(19) United States
(12) Patent Application Publication
(10) Pub. No.: US 2019/0290997 A1
(43) Pub. Date: Sep. 26, 2019

(54) GEOGRAPHY GAME USING MAPS AND EDIBLE CHIPS

(71) Applicants: Edwin V. Rivera, Seattle, WA (US); Veronica E.M. Rivera, Seattle, WA (US)

(72) Inventors: Edwin V. Rivera, Seattle, WA (US); Veronica E.M. Rivera, Seattle, WA (US)

(21) Appl. No.: 16/438,350

(22) Filed: Jun. 11, 2019

Related U.S. Application Data
(62) Division of application No. 15/393,116, filed on Dec. 28, 2016.
(60) Provisional application No. 62/271,738, filed on Dec. 28, 2015.

(51) Int. Cl. A63F 3/04; A23L 7/117

(52) U.S. Cl. CPC A63F 3/0434; A63F 2009/0012; A23L 7/117

(57) ABSTRACT

A geography game for learning geography and geographic information is disclosed that includes maps, scoresheets, lists of facts, and rules and instructions used to guide players on how to effectively use edible food items, such as chips, to learn geography through a fun and entertaining platform. The game provides marketing value to chip manufacturers and variations of the game add even more value by creating excitement and longevity. In one implementation, the edible chip is a triangular corn tortilla chip.

### BACKGROUND

### Technical Field

The present disclosure relates to games and, more particularly, to games utilizing edible food items as game pieces.

### Description of the Related Art

The subject of geography is fundamental to a well-rounded education, although geography is not often taught in schools as a stand-alone subject. As a result, maps of countries and continents may be difficult for students to understand and study. Memorization has traditionally been a key component to learning continents, countries, states, capitals, and their respective shapes and cartographic relationships to one another. Conventional teaching methods, through the use of memorization, fail to provide a fun and entertaining way for students to learn geographic regions and facts. Therefore, current methods of teaching geography can be enhanced by making geography more entertaining and fun to learn.

### BRIEF SUMMARY

A geography game may be summarized as comprising: a map illustrating a plurality of geographic regions; and a plurality of edible chips. The geography game may further comprise: a rule sheet; an answer sheet that provides a list of facts regarding the geographic regions; and a score sheet. The map may be packaged within a package of edible chips. The map, rule sheet, answer sheet, and score sheet may be packaged together inside a package of the plurality of edible chips. The edible chips may be triangular corn tortilla chips.

A method of playing a geography game may be summarized as comprising: taking a bite out of an edible chip by a first player of the game to form a remaining portion of the edible chip that has a shape; and selecting, by the first player of the game, a geographic region of a map that has a planform shape that visually resembles the shape of the remaining portion of the edible chip. The method may further comprise rendering, by a second player of the game, a judgment that the shape of the remaining portion of the edible chip matches the planform shape of the selected geographic region. The method may further comprise naming, by the first player of the game, a characteristic of the selected geographic region.

The method may further comprise: taking, by a second player of the game, a bite out of a second edible chip to form a remaining portion of the second edible chip having a shape; and selecting, by the second player of the game, a second geographic region of the map that has a planform shape that resembles the shape of the remaining portion of the second edible chip. The method may further comprise rendering, by a third player of the game, a judgment that the shape of the second remaining portion of the second edible chip matches the planform shape of the second selected geographic region. The method may further comprise repeating the taking and selecting actions by the first and second players until one of the first and second players of the game has matched seven remaining portions of edible chips to seven geographic regions. The seven geographic regions may be seven unique geographic regions.

### BRIEF DESCRIPTION OF THE RELATED DRAWINGS

The foregoing and other features and advantages of the present disclosure will become more readily appreciated from the following detailed description when taken in conjunction with the accompanying drawings, wherein:

FIG. 1 illustrates a map showing the planform shapes of the states of the United States;

FIG. 2 illustrates an edible chip in an unbitten state;

FIG. 3 illustrates an edible chip after a player has taken a bite from the edible chip;

FIG. 4 illustrates a score sheet for players to keep track of points; and

FIG. 5 illustrates a set of geography game components being positioned, located, and packaged within a bag of chips.

### DETAILED DESCRIPTION

In the following description, certain specific details are set forth in order to provide a thorough understanding of various disclosed implementations.

However, one skilled in the relevant art will recognize that implementations may be practiced without one or more of these specific details, or with other methods, components, materials, etc. In other instances, well-known structures, components, or both associated with maps and cartography, as well as the manufacture and distribution of food items, including chips and the like, have not been shown or described in order to avoid unnecessarily obscuring descriptions of the implementations.

Unless the context requires otherwise, throughout the specification and claims that follow, the word “comprise” and variations thereof, such as “comprises” and “comprising” are to be construed in an open inclusive sense, that is, as “including, but not limited to.” The foregoing applies equally to the words “including” and “having.”

Reference throughout this description to “one implementation” or “an implementation” means that a particular feature, structure, or characteristic described in connection with the implementation is included in at least one implementation. Thus, the appearance of the phrases “in one implementation” or “in an implementation” in various places throughout the specification are not necessarily all referring to the same implementation. Furthermore, the particular features, structures, or characteristics may be combined in any suitable manner in one or more implementations.

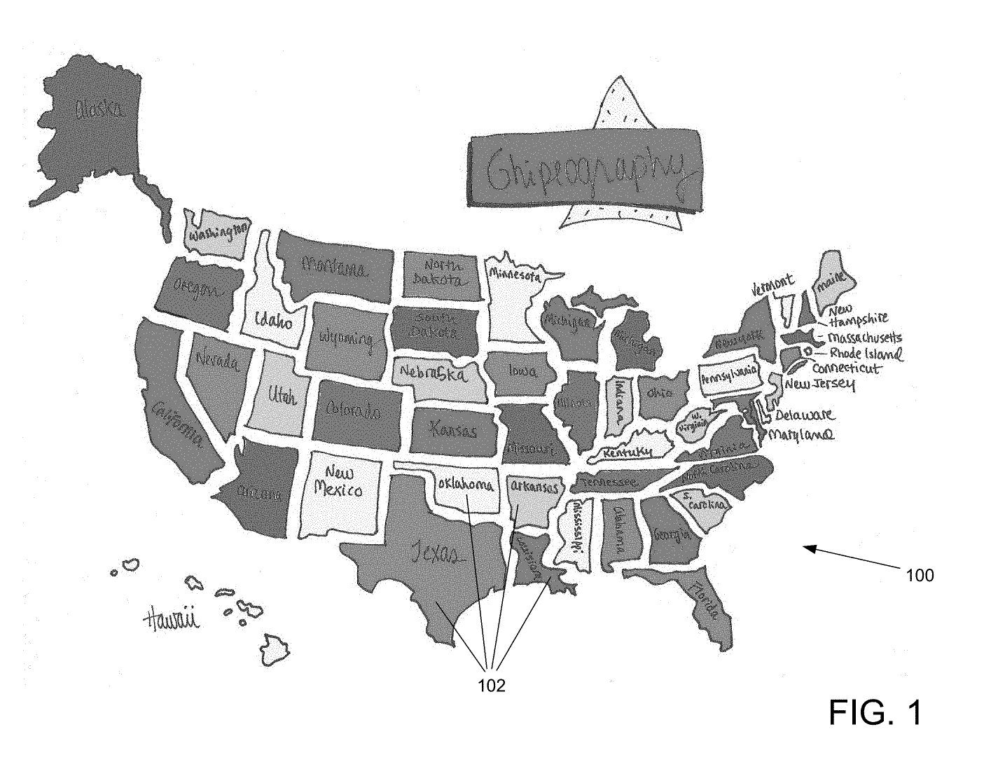

A set or a kit of game components includes one or more maps, such as one or more maps illustrating the world or various geographic regions thereof, such as a continent or a plurality of continents, a country or a plurality of countries, a subdivision of a country such as a state, province, bureau, region, territory, county, or city, or of a plurality thereof, or a plurality of land masses or bodies of water. The maps can include a piece of cardboard, a plastic mat, or any other planar game surface with the planform shape of the relevant geographic regions printed or otherwise graphically represented thereon. The maps are colorful, with adjacent geographic regions being indicated by different colors to make distinguishing the various geographic regions simple. For example, the maps can use alternating red, orange, yellow, green, blue, and purple colors to distinguish the various geographic regions from one another. In some implementations, to further enhance the distinctions between the various geographic regions, the geographic regions can be illustrated in an exploded view, wherein each geographic region is separated from each adjacent geographic region by neutral space. The maps can provide the name of each geographic region within the respective geographic region. FIG. 1 illustrates one example of a suitable map 100 of the United States showing all 50 states as geographic regions 102.

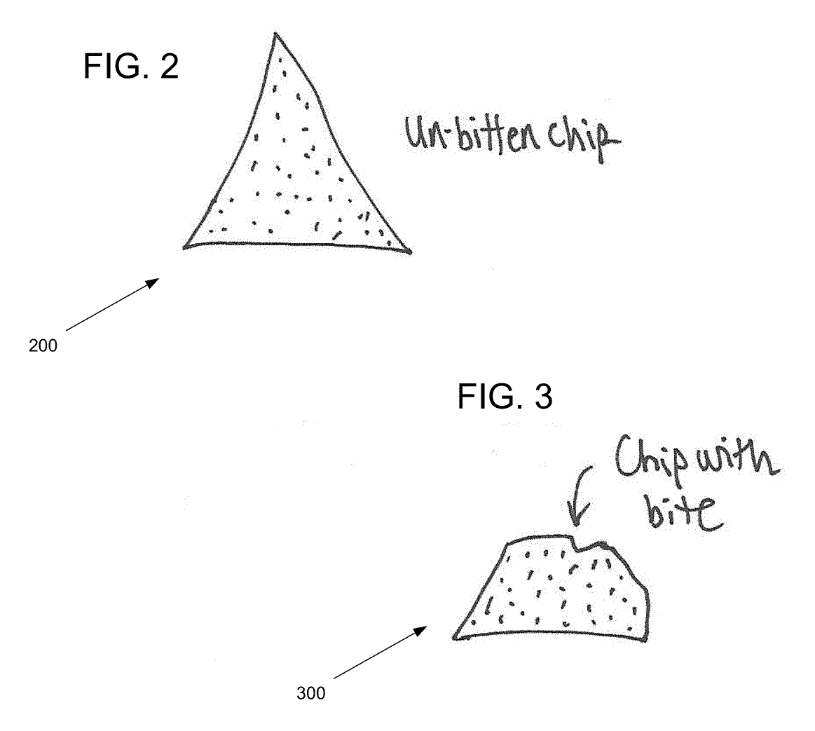

The kit also includes a set of edible chips 200 shown in FIG. 2. As used herein, the terms “edible chip” and “chip” include any food item suitable for consumption that is capable of being bitten to leave a remaining portion that has a shape that can have a visual similarity to a planform shape of a geographic region. Examples of suitable edible chips can include, but are not limited to, processed chips such as corn tortilla chips, potato chips, snack chips, crackers, pretzels, cookies, etc., whether fried, baked, or manufactured in other ways, whether circular, triangular, or of any other shape, and whether manufactured from potatoes, corn, flour, or other ingredients. The processing method can include baking, frying, drying, or other known process that renders the food item crisp and with a crunchy texture when chewed or bitten. It is important that the food item retain its shape when stored and after it is bitten. In some implementations, the chips are prepared triangular corn tortilla chips. For example, FIGS. 2 and 3 illustrate an unbitten triangular corn tortilla chip 200 and a bitten triangular corn tortilla chip 300, respectively.

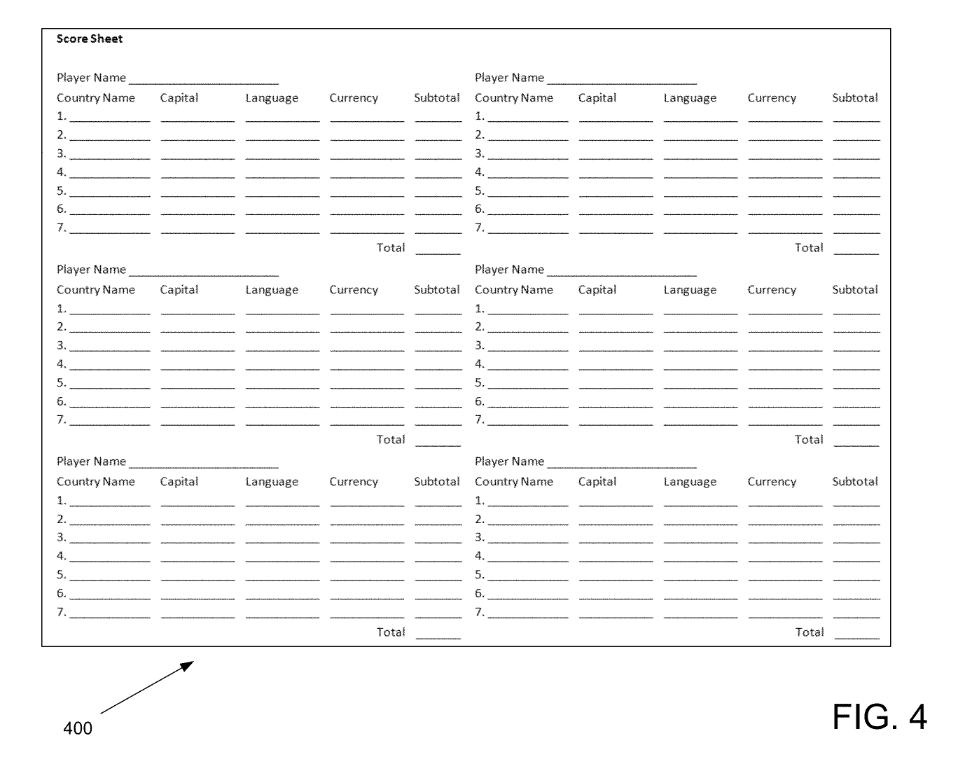

The kit also includes one or more score sheets and one or more writing implements to allow players to keep score on the score sheets as the game progresses. For example, FIG. 4 illustrates a score sheet 400 that is suitable for use during a game in which up to six players use a map of various countries and attempt to match the shapes of the remaining portions of chips to shapes of countries and then identify the capitals, languages, and currencies of those countries, until at least one of the players has matched seven distinct countries.

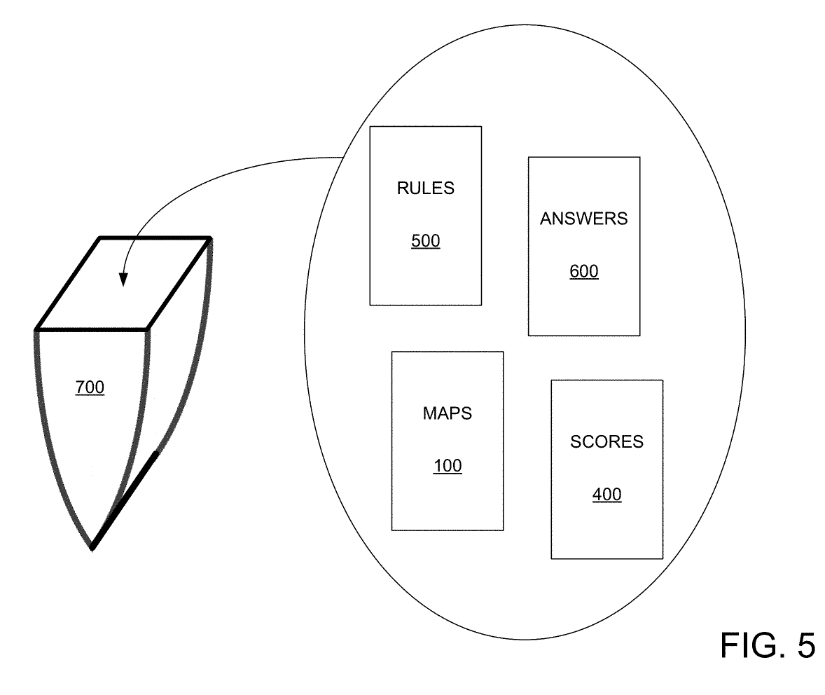

The kit further includes one or more answer sheets, such as answer sheets that provide a list of capitals of geographic regions illustrated in the maps, a list of postal abbreviations for the geographic regions, a list of official languages of the geographic regions, a list of currencies used in the geographic regions, a list of the official flowers or animals of the geographic regions, a list of time zones present within the geographic regions, or one or more lists of any other suitable characteristics of the geographic regions. The kit additionally includes one or more rule sheets that describe the method of game play and the rules of play as set forth herein. In some embodiments, the kit is prepackaged so that it can be included within a bag of chips, such as a bag of tortilla chips, or a bag or box that contains smaller bags of chips, pretzels, cookies, and the like. For example, FIG. 5 illustrates that the map 100, the score sheet 400, a rule sheet 500, and an answer sheet 600 can be positioned, located, or packaged together within a first package, and that the first package can be positioned, located, or packaged within a bag of chips 700. The kit can be used to play a game that can be marketed using the trademark CHIPEOGRAPHY or alternatively PRETZELOGRAPHY or COOKIEOGRAPHY.

The game is designed for play by two or more players. To begin a game, the components of the game, including one or more maps, one or more answer sheets, one or more rule sheets, one or more score sheets, a set of at least two edible chips, and a writing implement are placed on a table or other surface, such as the ground, around which the players are seated. The set of edible chips are left in a container, preferably an opaque or translucent container, to facilitate blind removal of the chips from the container by the players. A first one of the players can be selected, such as by rolling dice, flipping coins, etc., to take the first turn. In some implementations, the player to take the first turn can be selected by each player blindly removing one chip from the set of chips, with the player removing the largest chip or the heaviest chip becoming the player to take the first turn. Play begins with the selected first player taking the first turn, and play can progress with each of the other players taking turns in order, either clockwise or counter-clockwise, around the game table.

On each turn, the player whose turn it is selects a chip from the set of edible chips, e.g., blindly, and then takes a bite from the chip. The player then attempts to match the shape of the remaining portion of the chip to a shape of a geographic region, such as a continent, country, state, province, etc., on the map. In doing so, the player may or may not be allowed to rotate the chip and flip the remaining portion of the chip over. If, upon taking a bite from the chip, the remaining portion of the chip breaks into more than one portion, the player must then select one of the portions for play before continuing with the turn. The player then announces the geographic region having a planform shape the player believes the shape of the remaining portion or selected remaining portion of the chip most closely matches.

The rest of the players collectively decide whether the shape of the remaining portion of the chip sufficiently matches the shape of the announced geographic region. In some implementations, a collective decision requires just one of the other players deciding that the two shapes are sufficiently similar. If the rest of the players collectively decide that the two shapes are sufficiently similar, then the player whose turn it is scores one point and is allowed an opportunity to accumulate bonus points, such as by naming the capital of the geographic region, the postal abbreviation for the geographic region, the official languages of the geographic region, the currency used in the geographic region, or any other facts or characteristics of the geographic region agreed upon by the players before they begin playing the game. If the rest of the players collectively decide (either majority, super majority, or unanimous) that the two shapes are not sufficiently similar, then the player whose turn it is scores no points on that turn. Play then proceeds to the next player.

Some geographic regions, such as the U.S. states of Hawaii and Michigan, may comprise more than one distinct sub-region. Distinct sub-regions can be separated from one another by water or other geographic features, or may be actually connected to, but visually distinct from one another. For such geographic regions, one of the sub-regions, such as the big island of Hawaii, may be considered representative for the larger geographic region, or the players may attempt to match the shape of any of the sub-regions, such as the northern or the southern portion of Michigan, during their respective turns. In some cases, the players may decide before play begins which of these rules apply to the map they use during their game.

Some geographic regions, such as the U.S. states of Texas and Alaska, may have shapes that are more difficult than others to match, and therefore a player attempting to match a shape of such a state may be afforded more than one point for a successful match, or may be afforded more than one bite into their selected chip. For example, if a player successfully matches a shape of such a state with one bite from their selected chip, then that player may be afforded three points rather than one for the match. As another example, if a player successfully matches a shape of such a state with two bites from their selected chip, then that player may be afforded two points rather than one for the match. In some cases, the players may decide before play begins which of these rules apply to the map they use during their game.

On each turn, the player behind the player whose turn it is (the player who just completed a turn) takes the role of the scorer for that turn. On each turn, if the rest of the players collectively decide (majority, super majority, or unanimous) that the two shapes are sufficiently similar, then the scorer writes the name of the announced geographic region on the score sheet on a numbered blank line under the name of the player whose turn it is, indicating that the player has scored a point. When a player attempts to accumulate bonus points, the scorer checks that player's guesses against the appropriate answer sheet and if the player's guesses are correct, the scorer writes in the correct answers on a blank line adjacent to the name of the respective geographic region and under the name of the player whose turn it is. If the player's guesses are incorrect, then the scorer may or may not announce the correct answers.

As play proceeds around the table, each player will eventually take a number of turns before the game ends. If a player successfully matches one geographic region on one of their turns, then that player may not match the same geographic region on any subsequent turn. In some implementations, a game can be played until one of the players matches a predetermined threshold number of geographic regions, at which point the number of points accumulated by each of the players is totaled and the player with the most accumulated points is declared the winner of the game. The threshold number of geographic regions can be seven, ten, or any other suitable number agreed upon by the players before they begin playing the game.

In some alternative implementations, a game will be played until one of the players accumulates a predetermined threshold number of numerical points, at which point that player is declared the winner of the game. The threshold number of points can be seven points, ten points, or any other suitable number of points agreed upon by the players before they begin playing the game. In some alternative implementations, the game proceeds with each player seeking to accumulate letters rather than numerical points, and is be played until one of the players reaches a predetermined threshold number of letters, at which point that player can be declared the winner of the game. For example, a game can proceed with each player seeking to accumulate the letters “C,” “H,” “I,” “P,” “E,” “O,” “G,” “R,” “A,” “P,” “H,” and “Y,” thereby spelling out a trademark used in connection with the game to win. Such an implementation can be used without the bonus points described herein, or such an implementation can be used with the bonus points becoming bonus letters.

In some implementations, each player plays individually. In other implementations, the players partner with one another in pairs or combine into small teams to play as groups. When the players combine to play as groups, a collective decision that a proposed match between a shape of a remaining portion of a chip and a shape of a geographic region is successful can require just one of the other players, rather than an entirety of another pair or team, deciding that the two shapes are sufficiently similar.

In another implementation, the games described herein can be played without any electronic components and in a face-to-face setting.

Alternatively, various components of the game can be electronic. For example, a tablet or other computer including a digital display screen can be used to display one or more of a suitable map, game instructions, one or more fact sheets, a suitable score sheet, and any other components or information useful for allowing the players to play the game.

U.S. provisional patent application Ser. No. 62/271,738, filed Dec. 28, 2015, to which this application claims priority, is hereby incorporated herein by reference in its entirety. The various implementations described above can be combined to provide further implementations. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A geography game, comprising:
a map illustrating a plurality of geographic regions; and
a plurality of edible chips.

2. The geography game of claim 1, further comprising:
a rule sheet;
an answer sheet that provides a list of facts regarding the geographic regions; and
a score sheet.

3. The geography game of claim 1 wherein the map is packaged within a package of edible chips.

4. The geography game of claim 2 wherein the map, rule sheet, answer sheet, and score sheet are packaged together inside a package of the plurality of edible chips.

5. The geography game of claim 1 wherein the edible chips are triangular corn tortilla chips.

6-12. (canceled)
